(19) United States
(12) Patent Application Publication
(10) Pub. No.: US 2019/0320227 A1
(43) Pub. Date: Oct. 17, 2019

(54) INFORMATION PROCESSING DEVICE, INFORMATION PROCESSING SYSTEM, INFORMATION PROCESSING METHOD, AND STORAGE MEDIUM

(71) Applicant: SHARP KABUSHIKI KAISHA, Sakai City (JP)

(72) Inventor: KAZUYOSHI HADA, Sakai City (JP)

(21) Appl. No.: 16/289,658

(22) Filed: Mar. 1, 2019

(30) Foreign Application Priority Data
Apr. 13, 2018 (JP) 2018-077778

(51) Int. Cl. H04N 21/458; H04N 21/2668; H04N 21/237

(52) U.S. Cl. CPC H04N 21/458; H04N 21/237; H04N 21/2668

(57) ABSTRACT

The present invention relates to an information processing device (10) including a control section (11). The control section (11) obtains content identification information for identifying content, executes a searching process for identifying, with reference to content source information, one or more sources of the content which is identified by the content identification information which has been obtained, and outputs, via a communication section (18), information relating to the one or more sources which have been identified.

This Nonprovisional application claims priority under 35 U.S.C. § 119 on Patent Application No. 2018-077778 filed in Japan on Apr. 13, 2018, the entire contents of which is hereby incorporated by reference.

### TECHNICAL FIELD

An aspect of the present invention relates to an information processing device, an information processing system, an information processing method, and a storage medium.

### BACKGROUND ART

Conventionally, a technique is known in which content such as a video stored in a server can be obtained by accessing the server with use of a terminal device or the like which serves as a client.

Patent Literature 1 discloses a digital content receiving device which selects a link to content. In a case where the content has not been obtained, the digital content receiving device can notify a user of a reason why the content cannot be obtained.

### CITATION LIST

### Patent Literature

Patent Literature 1: Japanese Patent Application Publication, Tokukai, No. 2007-158978 (Publication Date: Jun. 21, 2007)

### SUMMARY OF INVENTION

### Technical Problem

However, the conventional technique merely specifies a cause due to which content desired by the user cannot be obtained. Under the circumstances, there is a possibility that a feeling of satisfaction of the user can be improved by, for example, presenting alternative information.

An aspect of the present invention is accomplished in view of the problem, and its object is to improve a feeling of satisfaction of a user when content desired by the user cannot be obtained.

### Solution to Problem

In order to attain the object, an information processing device in accordance with an aspect of the present invention includes: a communication section; and a control section, the control section obtaining, via the communication section, content identification information for identifying content, the control section executing a searching process for identifying, with reference to content source information, one or more sources of the content which is identified by the content identification information which has been obtained, and the control section outputting, via the communication section, information relating to the one or more sources which have been identified.

### Advantageous Effects of Invention

According to an aspect of the present invention, in a case where content desired by a user cannot be obtained, the information processing device provides information in relation to the content, and thus contributes to improvement in feeling of satisfaction of the user.

### BRIEF DESCRIPTION OF DRAWINGS

FIG. 1 is a functional block diagram illustrating an information processing system in accordance with Embodiment 1.

FIG. 2 is a view illustrating an example of a conventional screen displayed in a case where a valid period of content has expired.

FIG. 3 is a view illustrating an example of a screen in accordance with Embodiment 1 displayed in a case where a valid period of content has expired.

FIG. 4 is a sequence diagram showing a flow of processes in Embodiment 1.

FIG. 5 is a view illustrating an example of a screen displayed in a case where content has been bookmarked.

FIG. 6 is a view showing an example of a table that is contained in a database.

FIG. 7 illustrates an example in which a card indicating a link to content is displayed on a display included in the display device.

FIG. 8 is a functional block diagram illustrating an information processing system and a display device in accordance with Embodiment 2.

FIG. 9 is a sequence diagram showing a flow of processes in Embodiment 2.

FIG. 10 is a block diagram illustrating an example configuration of a computer that can be used as the terminal device or the information processing device.

### DESCRIPTION OF EMBODIMENTS

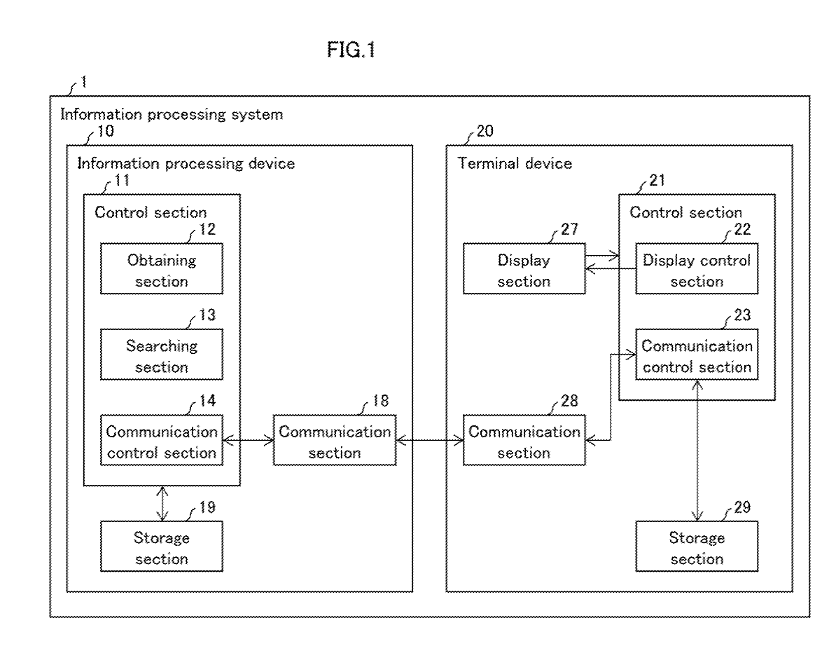

The following description will discuss embodiments of the present invention with reference to FIGS. 1 through 10.

### Embodiment 1

The following description will discuss an embodiment of the present invention with reference to FIGS. 1 through 6. Embodiment 1 explains a system that can present an alternative in a case where a valid period of content (such as a video) which has been bookmarked by a user has expired.

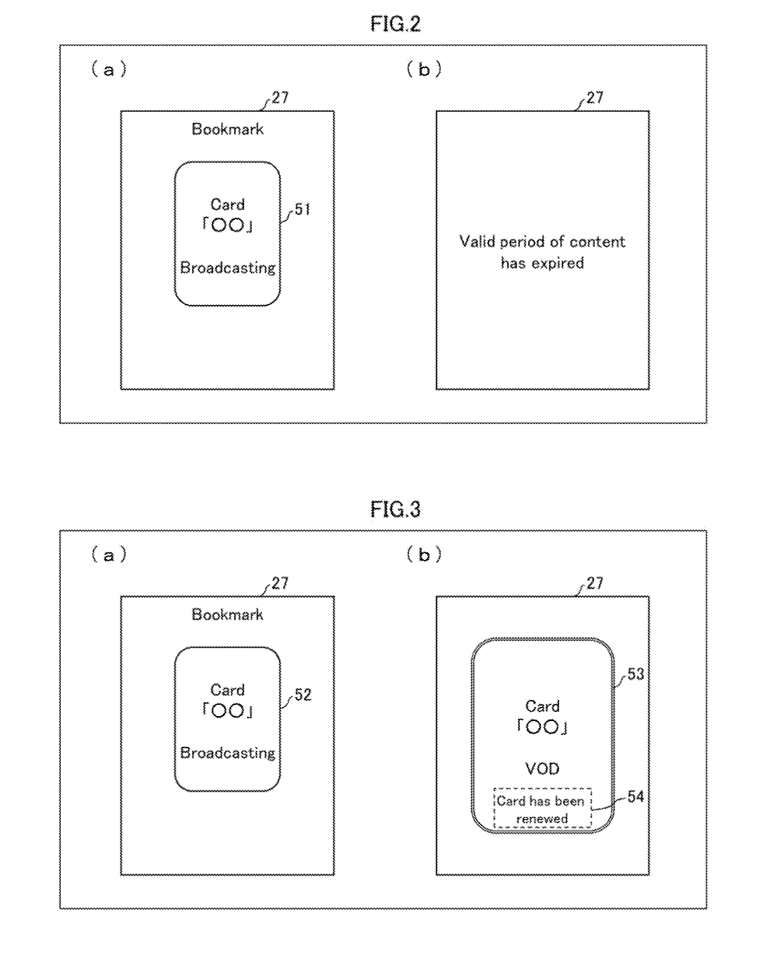

FIG. 2 is a view illustrating an example of a conventional screen displayed in a case where a valid period of content has expired. In a case where the user has selected a card 51 illustrated in (a) of FIG. 2 and a valid period of content corresponding to the card 51 has expired, for example, a screen as illustrated in (b) of FIG. 2 is displayed, and the user cannot access the content.

FIG. 3 is a view for explaining an example of a screen displayed in the above described case of Embodiment 1. In a case where the user has selected a card 52 illustrated in (a) of FIG. 3 and a valid period of content corresponding to the card 52 has expired, for example, a screen as illustrated in (b) of FIG. 3 is displayed. For example, the screen can include a text 54 of the like indicating that the card bookmarked (hereinafter bookmarked card) has been replaced with a card indicating alternative content. The card thus displayed as the replacement (hereinafter replacement card) can be displayed in a form with which the replacement card can be distinguished from the bookmarked card. For example, the replacement card can be displayed in a form in which a frame of the replacement card is indicated with a double line like a card 53 or can be displayed in a form in which a background color is different from that of the bookmarked card. By selecting the card 53, the user can view the content through VOD. Note that details of the “bookmark” indicated in FIG. 2 and FIG. 3 will be described later.

(Configuration of Information Processing System 1)

FIG. 1 is a functional block diagram illustrating an information processing system 1 in accordance with Embodiment 1. As illustrated in FIG. 1, the information processing system 1 includes an information processing device 10 and a terminal device 20.

The information processing device 10 is a device serving as a server that presents content to the user, and includes a control section 11, a communication section 18, and a storage section 19.

The control section 11 is a control device for comprehensively controlling the entire information processing device 10, and serves also as an obtaining section 12, a searching section 13, and a communication control section 14. The obtaining section 12 obtains content identification information for identifying content. Details of the content identification information will be described later. The searching section 13 refers to the content identification information and searches one or more sources for the content. The communication control section 14 controls a communication process that is carried out by the communication section 18.

The communication section 18 carries out a process of communicating with the terminal device 20 or with an external device such as a web server (not illustrated in FIG. 1). The storage section 19 is a storage device for storing various kinds of information. Moreover, information in relation to content such as a television program is stored in the storage section 19 in, for example, a database format.

The terminal device 20 serves as a client that can access content. The terminal device 20 includes a control section 21, a display section 27, a communication section 28, and a storage section 29.

The control section 21 is a control device for comprehensively controlling the entire terminal device 20, and serves also as a display control section 22 and a communication control section 23. The display control section 22 controls a screen display process that is carried out by the display section 27. The communication control section 23 controls a communication process that is carried out by the communication section 28.

The display section 27 is a touch panel which displays a video, an object, or the like. The user can carry out an input operation with respect to the terminal device 20 via the display section 27. Note that it is possible to employ a configuration in which the display section 27 does not function as a touch panel and merely serves as a display panel. In the case of such a configuration, the terminal device 20 further includes an input device such as a keyboard or a track pad (not illustrated in FIG. 1).

The communication section 28 carries out a process of communicating with the information processing device 10 or with an external device such as a web server (not illustrated in FIG. 1). The storage section 29 is a storage device for storing various kinds of information. The storage section 29 stores one or more bookmarks for content.

Note that the number of each of the constituent members included in the information processing system 1 is not limited to one (1), and it is possible to employ a configuration in which the number of any of the constituent members is two (2) or more. Moreover, one or some of the constituent members and functions of the information processing system 1 can be achieved by an external device(s) which are not illustrated in FIG. 1.

(Flow of Processes)

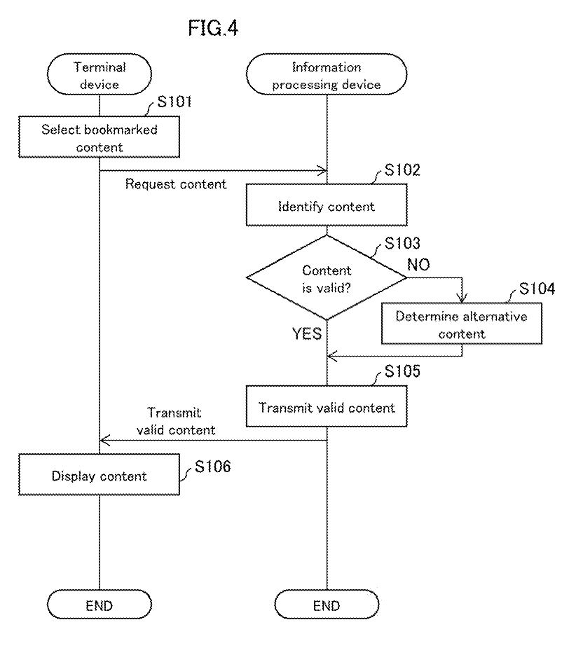

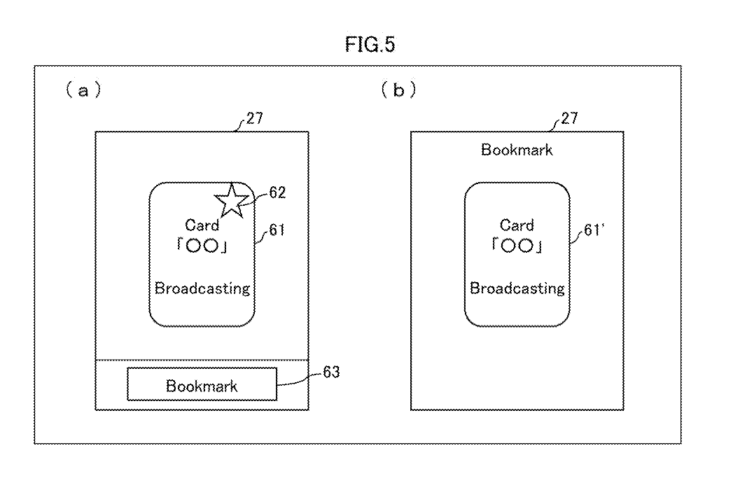

The following description will discuss, step by step, a flow of processes in Embodiment 1 with reference to FIG. 1 and FIGS. 4 through 6. FIG. 4 is a sequence diagram showing a flow of processes in Embodiment 1.

(S101)

In a step S101, the terminal device 20 requests the information processing device 10 to provide content indicated by a bookmark selected by the user.

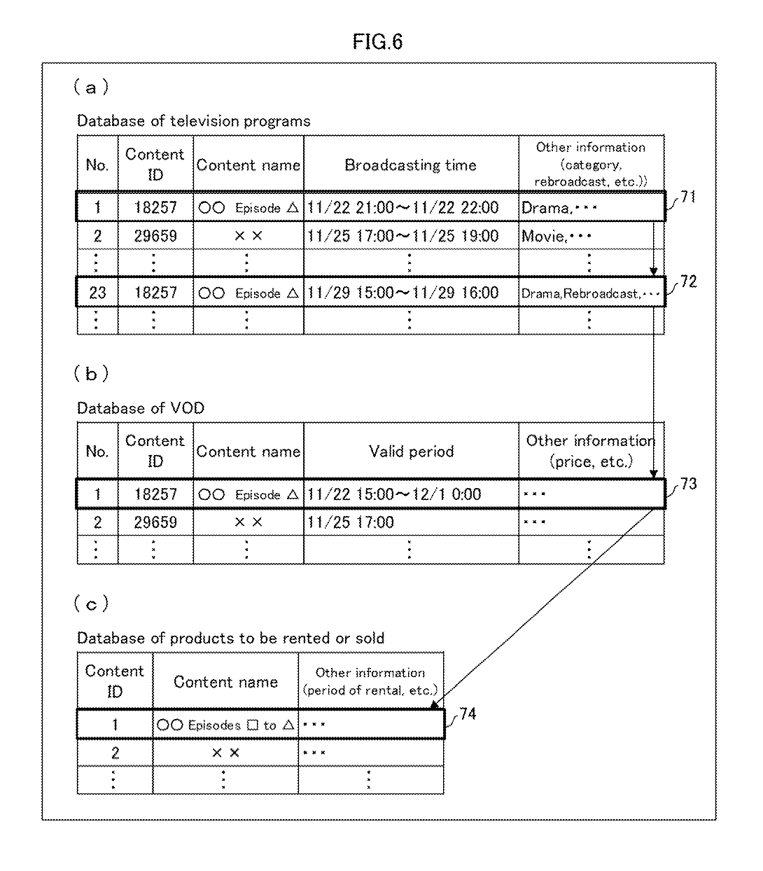

Here, the bookmark of content is additionally explained. (a) of FIG. 5 illustrates a display example of a card 61 that indicates a link to content. Note that a screen as illustrated in (a) of FIG. 5 can be displayed, for example, when the terminal device 20 proposes viewing or executing the content or when another device makes such a proposal via the terminal device 20.

As illustrated in (a) of FIG. 5 and the subsequent drawings, a link to content can be represented by, for example, a card-like object or the like. Information indicated by a card or the like is not limited to the link to content and can be, for example, an advertisement, weather information, a schedule of the user, or the like. It is possible that a plurality of cards or the like are displayed on the screen.

In the example illustrated in (a) of FIG. 5, a star mark 62 at the upper right of the card 61 indicates whether or not content indicated by the card 61 is bookmarked. In a case where the user has selected the star mark 62, the card 61 is bookmarked so that the card 61 can be referred to in a bookmark list page or the like. Further, for example, an inner side of the star mark 62 is colored in yellow, and thus the user recognizes that the card 61 has been bookmarked.

In a case where the user has selected a bookmark list button 63, a screen illustrated in (b) of FIG. 5 is displayed. (b) of FIG. 5 is a view illustrating an example of a bookmark list screen in which the user can refer to bookmarked items of content. The user can access content indicated by a card 61′ (see (b) of FIG. 5) by selecting the card 61′.

In this step, for example, the user selects arbitrary bookmarked content in the screen illustrated in (b) of FIG. 5. Next, the control section 21 requests, via the communication section 28, the information processing device 10 to provide information indicating the content.

Note that whether or not the content is held by the information processing device 10 is not limited. In a case where the content is not held by the information processing device 10, the information processing device 10 is said to be a proxy server that accesses, on behalf of the terminal device 20, a server which distributes content.

(S102)

In a step S102, the information processing device 10 identifies content which has been requested by the terminal device 20 in the step S101. Specifically, the control section 11 obtains, via the communication section 18, information indicating the request for the content. Next, with reference to the information, the obtaining section 12 obtains content identification information for identifying the content. Here, the content identification information is, for example, an identifier that is uniquely assigned to content, a content name, or the like. Next, the control section 11 identifies the content with reference to the content identification information. Moreover, in processes in this step and the following step S103, the control section 11 can refer to a database as appropriate which is stored in the storage section 19 (later described).

(S103)

In a step S103, the control section 11 determines, with reference to the database, whether or not the content identified in the step S102 is within a valid period. Note that a state in which the content is out of the valid period or a state in which the valid period has expired means a state in which distribution of the content has finished or a state in which the user cannot use the content due to a factor such as expiration of the user's contract.

In a case where the content is within the valid period, a process of a step S105 is carried out after the step S103. Whereas, in a case where the content is not within the valid period, a process of a step S104 is carried out after the step S103. In a case where the information indicating the request for the content in the step S102 includes information on the valid period of the content, the control section 11 can determine, with reference to the information on the valid period, whether or not the content is within the valid period.

(S104)

In the step S104, the searching section 13 determines, with reference to content source information indicative of a source of each item of content, alternative content which is an alternative to the content that has been identified by the control section 11 in the step S102.

Here, contents of the alternative content are identical with, similar to, or relating to those of the original content to be replaced. Further, the alternative content is to be distributed, provided, or sold (i) via a medium which is different from that for the original content and/or (ii) in a distribution time zone which is different from that of the original content. Note that, in this specification, the alternative content is also merely referred to as content as appropriate.

The following description will discuss examples of the database stored in the storage section 19. Specifically, the following explain an example of a database that contains information (e.g., content source information) relating to various kinds of content and an example of a process which is carried out by the information processing device 10 to determine alternative content with use of the database.

Each of (a) through (c) of FIG. 6 shows an example of a table that is contained in the database. Note that “content ID” and “content name” in each of (a) through (c) of FIG. 6 correspond to the content identification information. In examples shown in FIG. 6, a table name of each table corresponds to the content source information. Alternatively, it is possible to employ a configuration in which each table includes a column indicating content source information such as a television channel or a VOD distributor.

(a) of FIG. 6 shows an example of a table relating to television programs. Note that, in the example shown in (a) of FIG. 6, a period up to an end time of “broadcast time” of each record corresponds to the valid period of content. (b) of FIG. 6 shows an example of a table relating to VOD content. (c) of FIG. 6 shows an example of a table relating to products (such as a DVD) to be rented or sold.

The searching section 13 determines alternative content by referring to, in a predetermined order or in an arbitrary order, items of content which correspond to respective records in each of the tables and are candidates for the alternative content.

In a case where the content identified by the control section 11 in the step S102 is content corresponding to a record 71 and the content is not within a valid period, the searching section 13 refers to a record 72 that corresponds to an alternative content candidate for the content. In a case where the content corresponding to the record 72 is also not within a valid period, the searching section 13 then refers to a record 73 corresponding to another alternative content candidate. Similarly, in a case where the content corresponding to the record 73 is also not within a valid period, the searching section 13 then refers to a record 74 corresponding to still another alternative content candidate. For the content corresponding to the record 74, a valid period is not particularly specified and the content can be used. Therefore, the searching section 13 determines the content corresponding to the record 74 as alternative content to be presented to the user.

As such, in a searching process to search one or more sources of the content, the control section 11 (searching section 13) can identify one or more sources of the content by referring to content source information stored in the storage section 19.

According to the configuration, it is possible to provide the information processing device 10 which can identify one or more sources of the content by referring to information stored in the storage section 19.

Moreover, as above described, the searching section 13 can search and determine alternative content in stages. Note that other examples of alternative content corresponding to each item of content will be described later.

(S105)

In the step S105, the communication control section 14 transmits, to the terminal device 20, (i) content which is within a valid period or (ii) information which indicates a link to the content and relates to one or more sources of the content, via the communication section 18. Then, the communication control section 23 obtains the information via the communication section 28.

Note that, in a case where the S105 is a step next to the step S103, “the content” means content identified by the control section 11 in the step S102. Meanwhile, in a case where the S105 is a step next to the step S104, “the content” means alternative content determined by the searching section 13 in the step S104.

(S106)

Next, in a step S106, the display control section 22 controls the display section 27 to display (i) the content obtained by the communication control section 23 in the step S105 or (ii) information indicative of a link to the content.

In a case where the information displayed on the display section 27 is the information indicative of a link to the content, the information is displayed as, for example, a card 61′ illustrated in (b) of FIG. 5. Note that, in a case where the user has selected the card, the information processing device 10 can be used in the communication process as, for example, a proxy server for accessing the content. Alternatively, the communication process in such a case can be carried out without the information processing device 10.

The above is the flow of processes shown in the sequence diagram of FIG. 4.

As such, the information processing device 10 includes: the communication section 18; and the control section 11. The control section 11 obtains, via the communication section 18, content identification information for identifying content, the control section 11 executes a searching process for identifying, with reference to content source information, one or more sources of the content which is identified by the content identification information which has been obtained, and the control section 11 outputs, via the communication section 18, information relating to the one or more sources which have been identified.

According to the configuration, in a case where content desired by a user cannot be obtained, the information processing device 10 provides information in relation to the content, and thus contributes to improvement in feeling of satisfaction of the user.

### Alternative Content Example 1

The following description will discuss examples of alternative content that is searched and determined by the searching section 13 in a case where a valid period of bookmarked content has expired, with reference to this example and subsequent alternative content examples.

In a case where bookmarked content is, for example, a broadcasted television program, the searching section 13 can present, to the user, alternative content which is information indicative of programmed recording of the television program which is to be rebroadcasted.

That is, in a case where broadcasting of the content has ended and the control section 11 has identified that the content is to be rebroadcasted, the control section 11 can output, via the communication section 18, information relating to one or more sources of the content, specifically, a proposal to set programmed recording of the content to be rebroadcasted.

The configuration brings about an effect as follows: that is, in a case where broadcasting of content has ended, the user can easily set programmed recording of the content to be rebroadcasted.

### Alternative Content Example 2

In a case where bookmarked content is, for example, a broadcasted television program, the searching section 13 can present, to the user, alternative content which is VOD content corresponding to the television program.

That is, in a case where broadcasting of the content has ended and the control section 11 has identified that the content is to be supplied through video on demand, the control section 11 can output, via the communication section 18, information relating to one or more sources of the content, specifically, a proposal to view the content through the video on demand.

According to the configuration, in a case where broadcasting of content has ended, the user can easily view the content through VOD.

### Alternative Content Example 3

In a case where bookmarked content is VOD content, the searching section 13 can present, to the user, alternative content which is information indicative of programmed recording of, for example, a television program which is to be broadcasted and corresponds to the VOD content.

That is, in a case where the control section 11 has identified that supply of the content through video on demand has ended, the control section 11 can output, via the communication section 18, information relating to one or more sources of the content, specifically, a proposal to set programmed recording of the content to be broadcasted.

The configuration brings about an effect as follows: that is, in a case where supply of content through video on demand has ended, the user can easily set programmed recording of the content to be broadcasted.

### Alternative Content Example 4

In a case where bookmarked content is VOD content, the searching section 13 can present, to the user, alternative content which is a proposal to buy or rent a product such as a DVD which corresponds to the VOD content. Note that the buying or renting of the product can be carried out in a form of a physical medium such as a DVD or in a form of downloading through an electric telecommunication line. The same applies to the following examples of alternative content.

That is, in a case where the control section 11 has identified that supply of the content through video on demand has ended, the control section 11 can output, via the communication section 18, information relating to one or more sources of the content, specifically, a proposal to buy or rent a product that corresponds to the content.

The configuration brings about an effect as follows: that is, in a case where supply of content through video on demand has ended, the user can easily buy or rent the content.

### Alternative Content Example 5

In a case where bookmarked content is music distribution content, the searching section 13 can present, to the user, alternative content which is a proposal to buy or rent a product such as a CD which corresponds to the music distribution content.

That is, in a case where the control section 11 has identified that supply of the content by music distribution has ended, the control section 11 can output, via the communication section 18, information relating to one or more sources of the content, specifically, a proposal to buy or rent a product that corresponds to the content.

### Alternative Content Example 6

In a case where bookmarked content is game distribution content, the searching section 13 can present, to the user, alternative content which is a proposal to buy or rent a game which corresponds to the game distribution content.

That is, in a case where the control section 11 has identified that supply of the content by game distribution has ended, the control section 11 can output, via the communication section 18, information relating to one or more sources of the content, specifically, a proposal to buy or rent a product that corresponds to the content.

The configuration brings about an effect as follows: that is, in a case where supply of content by game distribution has ended, the user can easily buy or rent the content.

### Embodiment 2

The following description will discuss Embodiment 2 of the present invention with reference to FIGS. 1, 8, and 9. In Embodiment 2, a configuration will be described in which a user views content with use of a display device which is not a terminal device. For convenience, identical reference numerals are given to constituent members having functions identical with those of the constituent members described in the foregoing embodiment, and descriptions of such constituent members are omitted here.

In Embodiment 2, the user can bookmark a card or the like which indicates content and is displayed on a terminal device, as in Embodiment 1. Alternatively, as described below, the user can bookmark a card or the like which indicates content and is displayed on a display device.

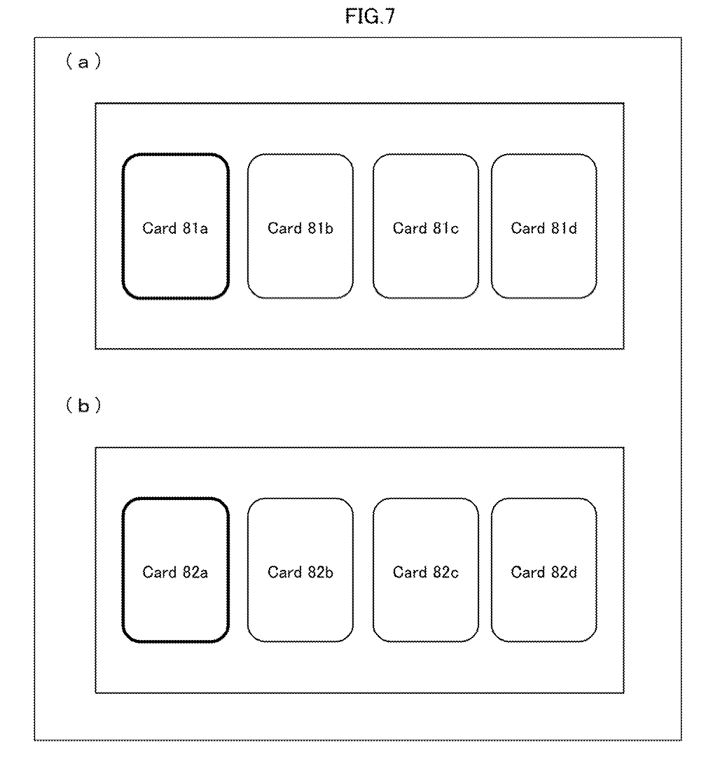

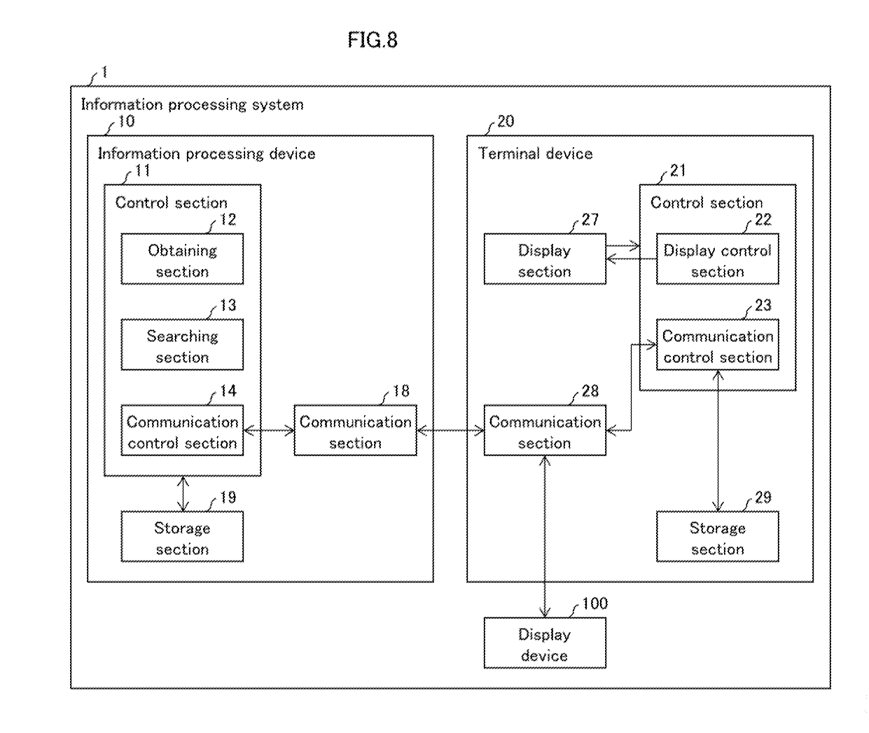

Each of (a) and (b) of FIG. 7 illustrates an example in which cards indicating respective links to content are displayed on a display included in the display device. A screen as illustrated in each of (a) and (b) of FIG. 7 can be displayed, for example, when the display device proposes viewing or executing the content or when another device makes such a proposal via the display device. Cards which are displayed on the display can be changed at a predetermined time or for each predetermined time period. In FIG. 7, cards on a screen illustrated in (a) of FIG. 7 are respectively changed to cards on a screen illustrated in (b) of FIG. 7 after a predetermined time period has elapsed. A card or the like which indicates content and is displayed on the display device can be bookmarked by a user operation carried out with respect to the terminal device which is synchronized with the display device.

(Configurations of Information Processing System 1 and Display Device)

FIG. 8 is a functional block diagram illustrating an information processing system 1 and a display device in accordance with Embodiment 2. Here, the information processing system 1 has a configuration identical with that illustrated in FIG. 1. The display device is a device such as a television receiver which can carry out screen display. Note that the display device has a function to carry out a process of communicating with an external device such as the terminal device 20. Although not illustrated in FIG. 8, the display included in the display device preferably has a size greater than that of the display section 27 of the terminal device 20. It is possible to employ a configuration in which the display device is included in the information processing system 1.

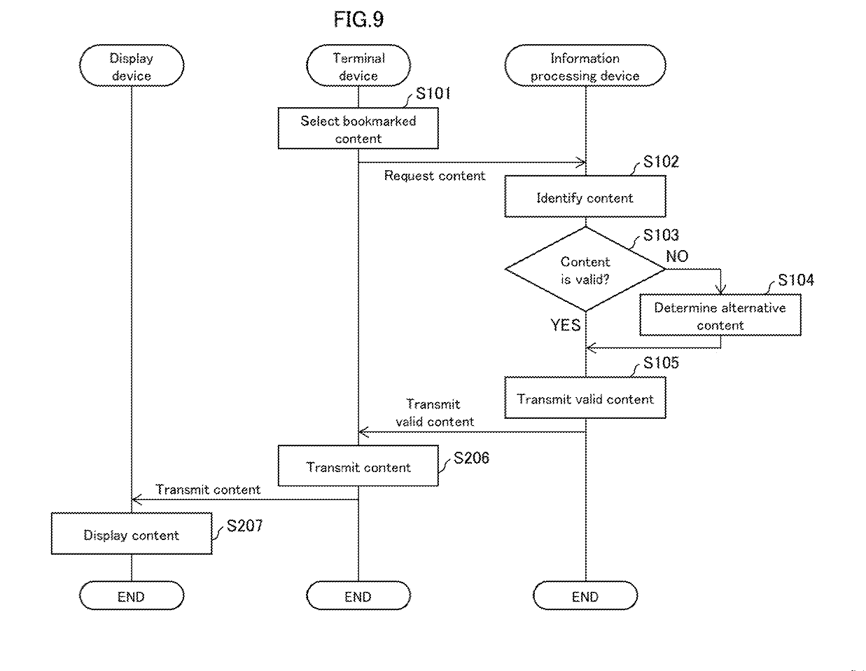

(Flow of Processes) The following description will discuss, step by step, a flow of processes in Embodiment 2 with reference to FIGS. 8 and 9. FIG. 9 is a sequence diagram showing a flow of processes in Embodiment 2.

(S101 through S105)

In the step S101 through the step S105, processes identical with those in Embodiment 1 are executed. After the process of the step S105 is executed, a process of a step S206 is subsequently executed.

(S206)

In the step S206, the communication control section 23 transmits, to the display device, content obtained in the step S105 or information indicative of a link to the content, via the communication section 28.

(S207)

Next, in a step S207, the content or the information indicative of a link to the content obtained in the step S206 is displayed on the display included in the display device.

Note that, in a case where the information displayed on the display is the information indicative of a link to the content and the user has selected a card or the like indicating the link with use of a remote controller or the like, the information processing device 10 and/or the terminal device 20 can be used in the communication process for accessing the content. Alternatively, the communication process in such a case can be carried out without the information processing device 10 and the terminal device 20.

The above is the flow of processes shown in the sequence diagram of FIG. 9.

In a case where content desired by a user cannot be obtained, the information processing device 10 provides information in relation to the content, and thus contributes to improvement in feeling of satisfaction of the user. Moreover, it is possible to confirm, on the screen of the display device, information relating to the content.

### Embodiment 3

In the foregoing embodiments, examples have been described in each of which one (1) information processing device 10 is used. Note, however, that the functions of the information processing device 10 can be achieved by separate servers. In a case where a plurality of servers are employed, the plurality of servers can be managed by the same operator or by different operators.

### Embodiment 4

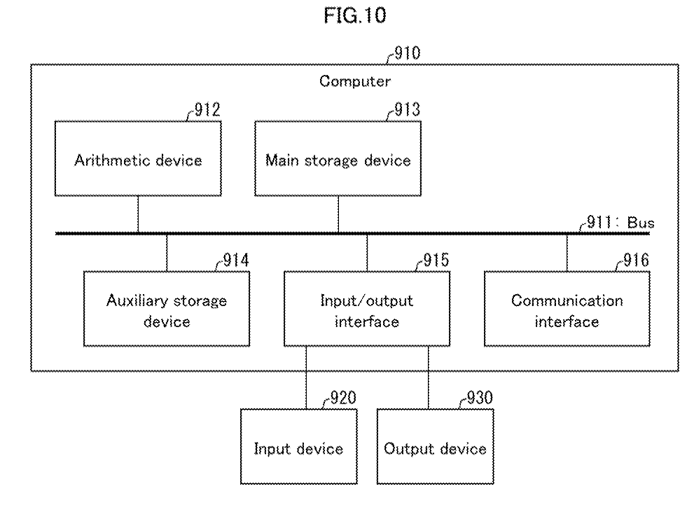

The blocks of the terminal device 20 and the information processing device 10 can be realized by a logic circuit (hardware) provided in an integrated circuit (IC chip) or the like or can be alternatively realized by software. In the latter case, it is possible to configure each of the terminal device 20 and the information processing device 10 with use of a computer as illustrated in FIG. 10.

FIG. 10 is a block diagram illustrating an example configuration of a computer 910 that can be used as the terminal device 20 or the information processing device 10. The computer 910 includes an arithmetic device 912, a main storage device 913, an auxiliary storage device 914, an input/output interface 915, and a communication interface 916 which are connected to each other via a bus 911. The arithmetic device 912, the main storage device 913, and the auxiliary storage device 914 can be, for example, a processor (e.g., a central processing unit: CPU), a random access memory (RAM), and a hard disk drive, respectively. The input/output interface 915 is connected with (i) an input device 920 with which a user inputs various information to the computer 910 and (ii) an output device 930 via which the computer 910 outputs various information to the user. The input device 920 and the output device 930 can be incorporated into the computer 910 or can be devices which are (externally) connected to the computer 910. For example, the input device 920 can be a keyboard, a mouse, a touch sensor, or the like, and the output device 930 can be a display, a printer, a speaker, or the like. Alternatively, it is possible to employ a device having functions of both the input device 920 and the output device 930, such as a touch panel in which a touch sensor and a display are integrated. The communication interface 916 is an interface via which the computer 910 communicates with an external device.

The auxiliary storage device 914 stores various programs for causing the computer 910 to function as any of the terminal device 20 and the information processing device 10. The arithmetic device 912 loads, on the main storage device 913, the various programs stored in the auxiliary storage device 914 and executes a command included in each of the various programs so that the computer 910 functions as each section of the terminal device 20 and the information processing device 10. Note that a storage medium which is included in the auxiliary storage device 914 for recording information such as the various programs only needs to be a computer-readable “non-transitory tangible medium” and can be, for example, a tape, a disk, a card, a semiconductor memory, a programmable logic circuit, or the like. The main storage device 913 can be omitted in a computer that can execute the program stored in the storage medium without loading the program in the main storage device 913. The number of each of the above devices (i.e., the arithmetic device 912, the main storage device 913, the auxiliary storage device 914, the input/output interface 915, the communication interface 916, the input device 920, and the output device 930) can be one or can be two or more.

The various programs can be obtained from outside of the computer 910. In this case, the various programs can be obtained via any transmission medium (such as a communication network or a broadcast wave). The present invention can also be achieved in the form of a computer data signal in which the various programs are embodied via electronic transmission and which is embedded in a carrier wave.

### Additional Remarks on Embodiments 1 Through 4

In the process of determining alternative content, the searching section 13 can (i) access, via the communication section 18, an external storage device (not illustrated in FIG. 1 and FIG. 8) which stores information relating to the various kinds of content and (ii) refer to the information.

In other words, in the searching process of searching one or more sources of content, the control section 11 (searching section 13) can identify one or more sources of the content by referring to content source information obtained from the external storage device via the communication section 18.

According to the configuration, it is possible to provide the information processing device 10 which can identify one or more sources of the content by referring to information stored in the external storage device.

It is possible to employ a configuration in which a bookmark for content is stored in the storage section 29 of the terminal device 20. Alternatively, it is possible to employ a configuration in which the bookmark for content is stored in the storage section 19 of the information processing device 10. In the former case, it is possible to employ a configuration in which content is automatically replaced with alternative content without a user operation of selecting the bookmark. In the latter case, it is possible to employ a configuration in which, in a case where a valid period of content has expired or the like, a process of replacing the content with alternative content is carried out when the terminal device 20 has accessed the information processing device 10. Alternatively, it is possible to employ a configuration in which the process of replacing the content with alternative content is carried out by the information processing device 10 at a predetermined time or for each predetermined time period.

In a case where there are a plurality of VOD services as alternative content candidates and the VOD services are provided by respective of a plurality of different operators, the searching section 13 can determine, as alternative content, a VOD service that is provided by an operator with which the user contracts for viewing. In a case where the user contracts with a plurality of operators for viewing, for example, (i) the searching section 13 can determine, as alternative content, a VOD service that is provided by an operator through which the user views videos with a higher frequency or (ii) the searching section 13 can determine, as alternative content, a VOD service that is provided by an operator through which the user viewed a video last time.

It is possible to employ a configuration in which the user can assign priorities to respective media from which the searching section 13 determines alternative content. In particular, in a case where VOD is a fee-based service, it is possible to employ a configuration in which, for example, the user can set whether VOD is prioritized or broadcasting/rebroadcasting (such as television broadcasting/rebroadcasting) is prioritized as alternative content to be determined by the searching section 13.

In a case where content desired by the user is, for example, a television program to be broadcasted and a bookmark corresponding to the content is selected before broadcasting of the program, the searching section 13 can search alternative content corresponding to the content and present the alternative content to the user.

In a case where a bookmark is set to, for example, a television program to be broadcasted, the terminal device 20 or the display device can notify, a predetermined time period before the time to broadcast the program, the user that broadcasting of the program is to start.

The information processing device 10 can present, to the user, a plurality of items of alternative content and/or a plurality of links to the respective items of alternative content at a time.

The above described embodiments are applicable to content in media or in forms which are different from those for the content described in the foregoing embodiments. Examples of such content encompass websites, still images such as comics, and text such as novels.

The following are additional remarks applicable to a configuration in which a display device is used as in Embodiment 2.

It is possible to employ a configuration in which bookmarking of content is carried out by operating, for example, a display device or a remote controller corresponding to the display device, and/or a bookmark is viewed on the display device. According to the configuration, in a case where the user has selected a card or the like which indicates a bookmark and is displayed on the display device, the display device can directly access the information processing device 10 by bypassing the terminal device 20.

It is possible to employ a configuration in which, in the step S105, the communication control section 14 included in the information processing device 10 transmits, via the communication section 18, content within a valid period or information indicative of a link to the content directly to the display device by bypassing the terminal device 20.

It is possible to employ a configuration in which, in the step S207 of Embodiment 2, information relating to content which is to be displayed or is being displayed on the display device is displayed on the display section 27 of the terminal device 20.

It is possible to employ a configuration in which, in the step S105, in a case where the information which the terminal device 20 has obtained from the information processing device 10 is information indicative of a link to content, (i) the display device accesses the content with reference to the link or (ii) the terminal device 20 accesses the content and the display device functions as a mere external display.

[Recap]

The information processing device 10 in accordance with an aspect 1 of the present invention includes: a communication section 18; and a control section 11, the control section 11 obtaining, via the communication section 18, content identification information for identifying content, the control section 11 executing a searching process for identifying, with reference to content source information, one or more sources of the content which is identified by the content identification information which has been obtained, and the control section 11 outputting, via the communication section 18, information relating to the one or more sources which have been identified.

According to the configuration, in a case where content desired by a user cannot be obtained, the information processing device 10 provides information in relation to the content, and thus contributes to improvement in feeling of satisfaction of the user.

It is possible that the information processing device 10 in accordance with an aspect 2 of the present invention further includes, in the aspect 1, a storage section 19 and, in the searching process, the control section 11 identifies one or more sources of the content with reference to the content source information which is stored in the storage section 19.

According to the configuration, it is possible to provide the information processing device 10 which can identify one or more sources of the content by referring to information stored in the storage section 19.

According to the information processing device 10 in accordance with an aspect 3 of the present invention, it is possible in the aspect 1 that: in the searching process, the control section 11 identifies one or more sources of the content with reference to the content source information which has been obtained from an external storage device via the communication section 18.

According to the configuration, it is possible to provide the information processing device 10 which can identify one or more sources of the content by referring to information stored in the external storage device.

According to the information processing device 10 in accordance with an aspect 4 of the present invention, it is possible in any of the aspects 1 through 3 that: in a case where broadcasting of the content has ended and the control section 11 has identified that the content is to be rebroadcasted, the control section 11 outputs, via the communication section 18, information relating to one or more sources of the content, the information being a proposal to set programmed recording of the content to be rebroadcasted.

The configuration brings about an effect as follows: that is, in a case where broadcasting of content has ended, the user can easily set programmed recording of the content to be rebroadcasted.

According to the information processing device 10 in accordance with an aspect 5 of the present invention, it is possible in any of the aspects 1 through 3 that: in a case where broadcasting of the content has ended and the control section 11 has identified that the content is to be supplied through video on demand, the control section 11 outputs, via the communication section 18, information relating to one or more sources of the content, the information being a proposal to view the content through the video on demand.

According to the configuration, in a case where broadcasting of content has ended, the user can easily view the content through VOD.

According to the information processing device 10 in accordance with an aspect 6 of the present invention, it is possible in any of the aspects 1 through 3 that: in a case where the control section 11 has identified that supply of the content through video on demand has ended, the control section 11 outputs, via the communication section 18, information relating to one or more sources of the content, the information being a proposal to set programmed recording of the content to be broadcasted.

The configuration brings about an effect as follows: that is, in a case where supply of content through video on demand has ended, the user can easily set programmed recording of the content to be broadcasted.

According to the information processing device 10 in accordance with an aspect 7 of the present invention, it is possible in any of the aspects 1 through 3 that: in a case where the control section 11 has identified that supply of the content through video on demand has ended, the control section 11 outputs, via the communication section 18, information relating to one or more sources of the content, the information being a proposal to buy or rent a product that corresponds to the content.

The configuration brings about an effect as follows: that is, in a case where supply of content through video on demand has ended, the user can easily buy or rent the content.

According to the information processing device 10 in accordance with an aspect 8 of the present invention, it is possible in any of the aspects 1 through 3 that: in a case where the control section 11 has identified that supply of the content by music distribution has ended, the control section 11 outputs, via the communication section 18, information relating to one or more sources of the content, the information being a proposal to buy or rent a product that corresponds to the content.

The configuration brings about an effect as follows: that is, in a case where supply of content by music distribution has ended, the user can easily buy or rent the content.

According to the information processing device 10 in accordance with an aspect 9 of the present invention, it is possible in any of the aspects 1 through 3 that: in a case where the control section 11 has identified that supply of the content by game distribution has ended, the control section 11 outputs, via the communication section 18, information relating to one or more sources of the content, the information being a proposal to buy or rent a product that corresponds to the content.

The configuration brings about an effect as follows: that is, in a case where supply of content through game distribution has ended, the user can easily buy or rent the content.

The information processing system 1 in accordance with an aspect 10 of the present invention includes: an information processing device 10; and a terminal device 20, the terminal device 20 transmitting, to the information processing device 10, content identification information for identifying content that is designated by a user, the information processing device 10 including a communication section 18 and a control section 11, the control section 11 obtaining, via the communication section 18, the content identification information from the terminal device 20, the control section 11 executing a searching process for identifying, with reference to content source information, one or more sources of the content which is identified by the content identification information which has been obtained, the control section 11 outputting, via the communication section 18, information relating to the one or more sources which have been identified, the terminal device 20 presenting, to the user, the one or more sources which have been obtained from the information processing device 10.

According to the configuration, it is possible to provide the information processing system 1 which contributes to improvement in feeling of satisfaction of the user in a case where content desired by the user cannot be obtained.

The information processing method in accordance with an aspect 11 of the present invention is a method for processing information by use of a device, the method including the steps of: obtaining content identification information for identifying content; executing a searching process for identifying, with reference to content source information, one or more sources of the content which is identified by the content identification information which has been obtained; and outputting information relating to the one or more sources which have been identified.

According to the method, in a case where content desired by a user cannot be obtained, the information processing device 10 provides information in relation to the content, and thus contributes to improvement in feeling of satisfaction of the user.

The control program in accordance with an aspect 12 of the present invention can be a control program for causing a computer to serve as the information processing device 10 described in any one of the aspects 1 through 9, the control program causing the computer to serve as the control section 11.

The information processing device 10 in accordance with each of the aspects of the present invention can be realized by a computer. In such a case, the present invention encompasses (i) a control program of the information processing device 10 which control program causes the computer to serve as the sections (software elements) included in the information processing device 10 for realizing the information processing device 10 and (ii) a computer-readable storage medium storing the control program.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Information processing system
10: Information processing device
11, 21: Control section
12: Obtaining section
13: Searching section
14, 23: Communication control section
18, 28: Communication section
19, 29: Storage section
20: Terminal device
22: Display control section
27: Display section
910: Computer
911: Bus
912: Arithmetic device
913: Main storage device
914: Auxiliary storage device
915: Input/output interface
916: Communication interface
920: Input device
930: Output device

1. An information processing device comprising:
a communication section; and
a control section,
the control section obtaining, via the communication section, content identification information for identifying content,
the control section executing a searching process for identifying, with reference to content source information, one or more sources of the content which is identified by the content identification information which has been obtained, and
the control section outputting, via the communication section, information relating to the one or more sources which have been identified.

2. The information processing device as set forth in claim 1, further comprising:
a storage section,
in the searching process, the control section identifying one or more sources of the content with reference to the content source information which is stored in the storage section.

3. The information processing device as set forth in claim 1, wherein:
in the searching process, the control section identifies one or more sources of the content with reference to the content source information which has been obtained from an external storage device via the communication section.

4. The information processing device as set forth in claim 1, wherein:
in a case where broadcasting of the content has ended and the control section has identified that the content is to be rebroadcasted, the control section outputs, via the communication section, information relating to one or more sources of the content, the information being a proposal to set programmed recording of the content to be rebroadcasted.

5. The information processing device as set forth in claim 1, wherein:
in a case where broadcasting of the content has ended and the control section has identified that the content is to be supplied through video on demand, the control section outputs, via the communication section, information relating to one or more sources of the content, the information being a proposal to view the content through the video on demand.

6. The information processing device as set forth in claim 1, wherein:
in a case where the control section has identified that supply of the content through video on demand has ended, the control section outputs, via the communication section, information relating to one or more sources of the content, the information being a proposal to set programmed recording of the content to be broadcasted.

7. The information processing device as set forth in claim 1, wherein:
in a case where the control section has identified that supply of the content through video on demand has ended, the control section outputs, via the communication section, information relating to one or more sources of the content, the information being a proposal to buy or rent a product that corresponds to the content.

8. The information processing device as set forth in claim 1, wherein:
in a case where the control section has identified that supply of the content by music distribution has ended, the control section outputs, via the communication section, information relating to one or more sources of the content, the information being a proposal to buy or rent a product that corresponds to the content.

9. The information processing device as set forth in claim 1, wherein:
in a case where the control section has identified that supply of the content by game distribution has ended, the control section outputs, via the communication section, information relating to one or more sources of the content, the information being a proposal to buy or rent a product that corresponds to the content.

10. An information processing system comprising:
an information processing device; and
a terminal device,
the terminal device transmitting, to the information processing device, content identification information for identifying content that is designated by a user,
the information processing device including a communication section and a control section,
the control section obtaining, via the communication section, the content identification information from the terminal device,
the control section executing a searching process for identifying, with reference to content source information, one or more sources of the content which is identified by the content identification information which has been obtained,
the control section outputting, via the communication section, information relating to the one or more sources which have been identified,
the terminal device presenting, to the user, the one or more sources which have been obtained from the information processing device.

11. A method for processing information by use of a device, said method comprising the steps of:
obtaining content identification information for identifying content;
executing a searching process for identifying, with reference to content source information, one or more sources of the content which is identified by the content identification information which has been obtained; and
outputting information relating to the one or more sources which have been identified.

12. A non-transitory computer readable storage medium that stores a control program for causing a computer to serve as an information processing device recited in claim 1, the control program causing the computer to serve as the control section.
